(19) United States
(12) Patent Application Publication
(10) Pub. No.: US 2013/0247722 A1
(43) Pub. Date: Sep. 26, 2013

(54) Nail-in Anchor Pin Setting Device and Method of Installing Anchors Pins

(71) Applicant: Ronald Sehring, Jeannette, PA (US)

(72) Inventor: Ronald Sehring, Jeannette, PA (US)

(21) Appl. No.: 13/772,424

(22) Filed: Feb. 21, 2013

Related U.S. Application Data
(60) Provisional application No. 61/615,662, filed on Mar. 26, 2012.

(51) Int. Cl. B25D 17/00

(52) U.S. Cl. CPC B25D 17/00
USPC 81/23; 29/525.08

(57) ABSTRACT

Disclosed is a nail-in anchor pin setting device that is used in conjunction with a hammer to set an anchor into a surface prior to driving the setting nail thereinto to expand the anchor. The device comprises an elongated, largely cylindrical device having an impact end and a driving end. The impact end receives driving loads from a hammer, while the driving end comprises an internal bore to accept the anchor pin therethrough. The driving end is placed against the collar of the anchor while the anchor pin is accepted through the device bore. The hammer end is driven against the collar to force the anchor into a wall surface substrate, whereafter the tool can be removed from the anchor to reveal the set anchor and exposed nail pin to be driven into the anchor for expansion and securement thereof.

### CROSS REFERENCE TO RELATED APPLICATION

This application claims the benefit of U.S. Provisional Application No. 61/615,662 filed on Mar. 26, 2012, entitled “Nail Pin Anchor Setting Device.” The above identified patent application is herein incorporated by reference in its entirety to provide continuity of disclosure.

### BACKGROUND OF THE INVENTION

1. Field of the Invention

The present invention relates to hand tools for setting fastener anchors into a support material. More specifically, the present invention comprises a nail-in anchor pin setting device that allows a user to forcibly insert the anchor into a support material without prematurely expanding the anchor by forcing the fastener thereinto before the anchor is set.

Wall anchors are expanding support devices that provide secure fitment and support along a wall surface. These devices generally expand or stretch outward to spread the load of supported items and to reduce any gaps between the nail/pin and the support wall, reducing the likelihood that the material supporting the anchor will fail, causing damage to supported items or damage to the wall itself. These devices are useful for supporting heavy loads in material not otherwise designed to support heavy objects (drywall), and further for inserting an anchor into a support wall comprised of a hardened material that may require pre-drilling. The wall anchors expand within the pre-drilled hole to ensure a close-tolerance fit with the nail or pin, preventing any loosely positioned support nails and therefore providing sound support for hanging objects along a wall.

Nail-in anchor pins are devices that include an expanding body section, an inner bore extending through the body section, a collar, and a protruding nail or pin that is interference fit with the body section inner bore. Generally these anchors are used in masonry walls where a hole is pre-drilled to accept the anchor body section therein. Once the anchor is in place, the nail or pin is driven into the body section, expanding the bore of the body section and expanding the overall volume of the anchor to fill voids in the pre-drilled hole and to ensure the nail is firmly in place. Close tolerance fitment ensures the assembly can support heavy loads against a concrete or similar masonry wall. Problems arise during the installation process of such anchors if the nail is driven into the anchor body section prematurely, causing expansion of the joint before the anchor is properly seated. Since the nail and anchor are concentric with one another, it can be difficult to drive the anchor without also driving the nail. Generally the two are separated from one another and the anchor is set before the expansion nail is entered thereinto. This procedure is both time-consuming and inefficient, and further still some anchors do not have separable pins/nails to accommodate this two-step process.

The present invention provides an anchor setting tool that is designed for use in conjunction with a hammer to insert the anchor body section into a pre-drilled hole while the nail within the body section remains attached thereto but withdrawn from the bore while the anchor is being driven. Some types of nail-in anchor pins do not allow for separation of the nail and anchor, therefore a means of driving the anchor without setting the nail into the anchor is desired. The present invention provides a new tool that can ensure the nail is not inserted prematurely into the anchor body section while the anchor is being driving into a wall surface. The device contacts the collar portion of the anchor only, driving the anchor inward without driving the expansion nail. Once the anchor body has been inserted, the tool can be removed and the nail can be hammered into the anchor to expand the element and provide a secure support for hanging articles.

2. Description of the Prior Art

Devices have been disclosed in the prior art that relate to anchor setting tools. These include devices that have been patented and published in patent application publications, and generally relate to anchor setting devices that function with hammer drive rotary tools or complicated assemblies for setting a nail-in anchor pin. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,814,631 to Wallek discloses an expansion anchor setting device that is adapted for use with a rotary hammer drive. The device comprises a cylindrical shaft having a driving end that engages an expansion slug within an expansion anchor, as well as an attachment end configured to engage a drill device. A sliding sleeve covers and uncovers the device driving end to support the expansion anchor within the sleeve prior to drilling the anchor into a wall, whereafter the sleeve is drawn over the device body as the anchor is set into the wall. A retaining ring prevents the sleeve and body portion from separation. While the Wallek device provides a tool for use with setting expansion anchors, it is adapted for use with rotary drill devices rather than a hammer. The Wallek device threadably engages the wall anchor and drives it forward, while the present invention is a striking tool that drives the anchor inward while retaining the expansion element or fastener within its body section.

Similar to Wallek is U.S. Pat. No. 4,899,431 to Borntrager, which discloses a threaded anchor setting tool. The device comprises a body having a longitudinal bore and a pinway passing from outside of the body from the bore. Through the pinway is a laterally extending shaft that is connected to a threaded shaft within the bore. The threaded shaft threadably connects to an anchor to be set within a wall. The shaft is driven forward through the bore, and thus advancing the anchor by way of a nut engaged on the proximal end of the tool, which connects to the threaded shaft and drives it forward. As with the Wallek device, the Borntrager device utilizes a threaded connection with the anchor to drive it forward. The present invention is designed to provide a striking tool that can be used to drive an anchor into a wall material without a threaded connection.

U.S. Pat. No. 6,915,936 to Estes discloses a nail-pin anchor tool that is connects to a rotary impact hammer for setting and installing a nail-pin anchor. The device comprises a drill bit that receives percussive forces from the drill to move a driver within the bore of the device, driving inward the nail and nail-pin anchor member simultaneously. The device includes an internal spring and a moving driver element to drive the nail into the anchor as the distal end of the bore drives the nail-pin anchor. In this way, the anchor and the nail are driven into the wall in a single process, rather than first setting the anchor and then inserting a nail to expand the anchor. The present invention contemplates a device that allows a user to independently drive the anchor into a wall while the nail is largely outside of the anchor. Once set, the user can then drive the nail into the anchor to expand the joint and create a secure support.

Finally, U.S. Pat. No. 6,490,773 also to Estes discloses a tool for driving and setting a nail-in expansion anchor. The device comprises a sleeve with a drive pin for use in conjunction with a hammer. The device includes a locking mechanism that does not allow relative motion of the drive pin in relation to the sleeve. This allows the anchor collar to be impacted while the nail within the collar is not driven. The drive pin can then be unlocked to allow the drive pin to be struck and extend through the collar to drive the nail into the anchor. While disclosing a novel and useful setting tool, the Estes device is more complicated and requires several steps to use. The present invention is suitable for setting the anchor by driving its collar, whereafter the tool is removed and the hammer alone is used to drive the nail into the collar.

The present invention provides a one-piece, static tool that is used to set anchor-pins into pre-drilled holes while preventing pre-expansion of the anchor. The device comprises an elongated body that abuts against the anchor outer collar. The proximal end of the tool is struck by a hammer tool to impart load onto the collar only, forcing the anchor into the pre-drilled hole while not contacting the expansion nail. The tool is simple and efficient, reducing installation steps and eliminating waste with regards to anchors prematurely expanded and made used prior to being inserted into the wall. It is submitted that the present invention is substantially divergent in design elements from the prior art, and consequently it is clear that there is a need in the art for an improvement to existing anchor pin driving devices. In this regard the instant invention substantially fulfills these needs.

### SUMMARY OF THE INVENTION

In view of the foregoing disadvantages inherent in the known types of anchor pin driving devices now present in the prior art, the present invention provides a new driving device that can be utilized for providing convenience for the user when setting anchor pins into pre-drilled holes without expanding the anchor joint prematurely.

It is therefore an object of the present invention to provide a new and improved anchor pin driving device that has all of the advantages of the prior art and none of the disadvantages.

It is another object of the present invention to provide an anchor pin driving device that is a unitary structure having a hammer-striking end and an anchor collar engaging end that requires no moving parts to operate.

Another object of the present invention is to provide an anchor pin driving device that allows a user to drive the collar of an anchor pin without driving the nail or pin into the bore of the anchor during installation.

Yet another object of the present invention is to provide an anchor pin driving device that can be provided in a set of driving tools that provide different diameter members and different bore sizes to accommodate anchors of different sizes and shapes.

Another object of the present invention is to provide an anchor pin driving device that is inexpensive to manufacture and inexpensive for the user to obtain and deploy.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a view of the present invention in a working state, driving an anchor pin into a concrete surface to support an article therealong.

FIG. 3 shows a cross section view of the device in a working state, driving the collar of an anchor pin while the expansion nail remains static during the installation process.

### DETAILED DESCRIPTION OF THE INVENTION

Reference is made herein to the attached drawings. Like reference numerals are used throughout the drawings to depict like or similar elements of the anchor pin driving device. For the purposes of presenting a brief and clear description of the present invention, the preferred embodiment will be discussed as used for driving a cement wall anchor pin device. The figures are intended for representative purposes only and should not be considered to be limiting in any respect.

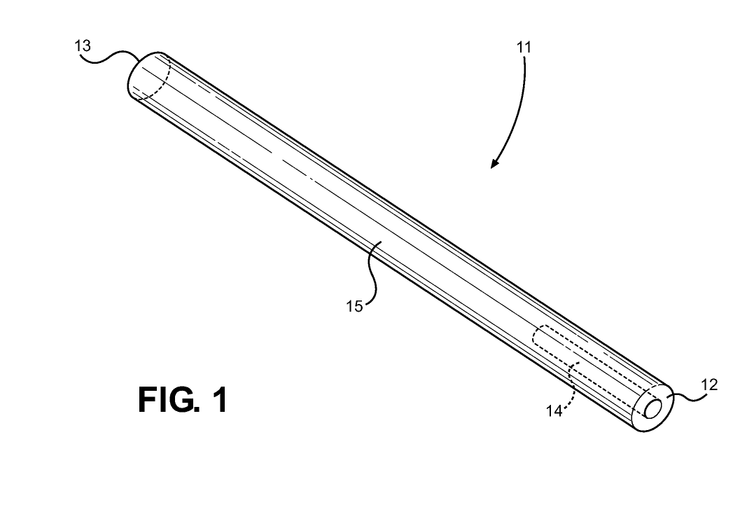

Referring now to FIG. 1, there is shown a perspective view of the anchor pin driving device 11 of the present invention. The device comprises an elongated body structure 15 having a first hammer impact end 13 and a second driving end 12. The body section 15 is an elongated structure that can take several different shapes. As shown in FIG. 1, the body is largely cylindrical, having an outer diameter for which the user to grasp with one hand to set against an anchor pin while grasping a hammer tool in a second hand. The driving end 12 of the device further comprises an aperture that leads to a hollow inner bore 14, which is designed to accommodate an anchor pin or nail therein. in this way, the nail enters the bore 14 and is not driven, while the tool driving end 12 rests against the anchor collar region for driving the collar into the wall surface without also driving the expansion nail.

The tool preferably comprises a metallic and hardened material such that it can be used repeatedly without bending or having its impact end deformed from repeated blows. The outer surface may be smooth or may further be textured for increased grip, while the dimensions of the device are dependent upon the given user application, where a larger diameter and larger bore driving tool is required for larger anchor pins, and vise versa.

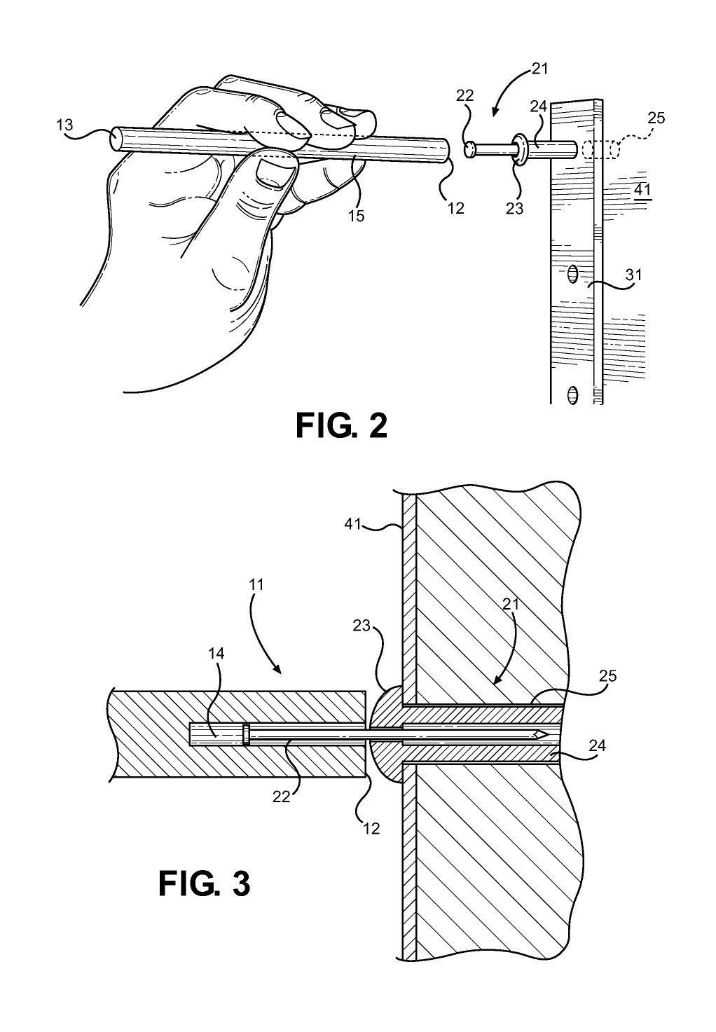

Referring now to FIG. 2, there is shown a view of the present invention in a working state, driving an anchor pin 21 into a cement wall surface 41 through a pre-drilled hole 25. In this view, a user is utilizing an anchor pin 21 to support an article 31 against a cement wall 41, whereby the anchor provides a close tolerance and secure fastening of the article 31 to a wall 41 whose material would otherwise make it difficult using a bare nail. Predrilled holes 25 in cement tend to deteriorate or give way to bare nails, which causes the nail to be loosely supported within the hole 25 and thus provide little securement of heavier objects. The use of an expanding anchor fills any voids in the predrilled hole 25 and ensures uniform friction against the shank of the nail in the hole such that the nail will not easily pull out or be withdrawn from the hole, thus providing adequate support for articles against the cement wall surface 41.

In use, the present invention sets the anchor 21 into the predrilled hole 25 without expanding the anchor body section 24 in the process. The anchor 21 comprises an expanding body section 24, a collar or head 23, and an internal bore that accepts and is interference fit with an anchor nail or pin 22. The present invention is utilized to drive the body section 24 into the hole 25 by first positioning the driving end 12 of the tool against the anchor collar 23 and accepting the nail 22 into the driving end bore. Once the tool is aligned, the user maintains purchase of the tool body 15 and uses a hammer to strike the impact end 13 of the tool, driving the anchor 21 into the hole 25 without driving the nail 22 relative to the anchor in the process. Once the collar 23 is flush with the wall or the article 31 outer surface, the tool can be removed and the nail 22 can be driven into the anchor body 24 to expand the anchor and secure the anchor into the wall.

Referring now to FIG. 3, there is shown a cross section view of the present invention in a working state, driving an anchor pin 21 into a wall surface 41. To drive the anchor pin body section 24 into the predrilled hole 25, the driving end 12 of the device abuts the anchor collar 23. Impact energy from the striking of a hammer against the striking end of the tool is imparted on the collar 23 and into the body section 24, causing the assembly to overcome any friction with the hole 25 inner surfaces. This causes the body 24 of the collar to forcibly insert into the hole 25 until the collar 23 is flush with the wall exterior surface or the exterior surface of the supported item. During this operation, the expansion nail 22 of the anchor is retained within the bore 14 of the tool 11. The impact loads are therefore not imparted on the nail 22 and the relative positioning of the nail 22 with respect to the collar 23 does not change, eliminating the possibility of the anchor body 24 being expanded prior to full insertion into the hole 25. Once properly seated into the hole 25, the body section 24 can be expanded by the forcible insertion of the nail 22, which can be freely struck by a hammer tool without the use of the tool 11. Alternatively, the tool 11 can be inverted such that the striking end of the tool is placed against the nail and is used as a punch tool for driving the nail 22 until it is flush with the collar 23. In this inverted configuration, the driving end of the tool is struck by a hammer and the flush surface of the striking end is utilized to drive the nail 22 into the anchor. This prevents the user from inadvertently striking the wall surface 41 and effectively moves the striking point for the hammer away from the wall.

The present invention allows builders, construction workers, and do-it-yourselfers to confidently set a hammer driven anchor pin into a wall surface without wasting time and materials. The possibility of pre-expanding a pin anchor is eliminated, as the tool can be used to properly seat an anchor and thereafter used to actually drive the expansion nail into the anchor body to finish the installation process. The device ensures that the body of the anchor may be fully set into the wall before it expands, eliminates waste, and eliminates steps to installation. The device is small, portable and may easily fit into a user's existing tool belt or tool box. When deployed, a plurality of different sizes may be provided to a user for anchors and expansion nails of different dimensions, such that anchors for different applications may be accommodated by different sized tools.

The material of the device is preferably a metallic structure, such as steel or aluminum, having a hardened outer surface that does not readily deform under impact loads on either end of the tool. The material of the tool body further is designed to withstand impacting loading without bending or failing. The tool is hardened to prevent surface deformations, and may undergo a cold forming process during fabrication to increase toughness and surface hardness. This may include a forging process, a surface shot peening process, or similar hardening process known in the art of striking tools such that the structure is sufficient to withstand repeated blows over time.

The applications for the present invention include use with pin anchors of various styles and designs. These include anchors suitable for different load capacities and anchors suitable for different wall substrates. The present invention may be used to drive anchors into upstanding wall surfaces, ceilings, barriers, or other surfaces that may require an expanded joint for supporting a nail or pin therein and for supporting load on the nail imparted by a hanging body. It is not desired to limit the present invention to a specific anchor pin type or surface substrate, but rather it is desired to disclose a device suitable for driving a pin anchor without prematurely engaging the anchor prior to placement into the substrate surface.

Accompanying the device of the present invention is an associated method of use, which prescribes a series of steps to prevent material waste and reduce inefficiencies in the anchor installation process. The first step is to pre-drill a hole into a wall surface. After the hole is prepared, an appropriately sized anchor pin is chosen to fill the hole, where the diameters of the hole are within the design tolerances of the chosen anchor. A work piece to be supported may be positioned over the hole where the anchor will sandwich the work piece between the anchor and the wall, or further the anchor can be inserted directly into the bare hole in the wall. The anchor body is held against the hole opening as the driving end of the present device is placed against the anchor collar. The expansion nail of the anchor is inserted into the bore of the present tool driving end, whereafter the tool impact end is impacted with a hammer until the body section is fully inserted into the hole and the collar is flush with the wall or work piece exterior surface. Once inserted, the tool is inverted and the striking end is utilized to drive the nail into the anchor body, expanding the body to secure the anchor in the hole. Using this method, the anchor is not prematurely expanded and therefore no wasted anchors are created in the installation process. The user further does not have to use caution with respect to inserting the body section without expanding it prior to full insertion. Any strain on the user is removed, while inverting the tool for use as a punch reduces the likelihood of damage the work piece or wall surface when finishing the installation procedure.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A nail-in anchor pin driving tool, comprising:
an elongated body section having a first impact end and a second driving end;
said second end further comprising an aperture and central bore therethrough for accepting a nail of an anchor pin;
said first and second end comprising a hardened material such that repeated impact loading does not readily deform said ends;
said body section comprising a sufficient stiffness such that repeated impact loading does not readily bend said body.

2) The device of claim 1, wherein said body section further comprises an exterior surface texture to improve purchase thereon.

3) The device of claim 1, wherein said tool material further comprises a hardened metallic material.

4) A method of driving and setting a nail-in anchor pin device, comprising the steps of:
pre-drilling a hole into a surface to accept an anchor therein, said anchor having an expanding body section, an interior bore, a nail to be driven within said bore, and a collar;
choosing an appropriately sized anchor to fit within said pre-drilled hole;
aligning said anchor with said hole and positioning a driving tool having a driving end, an impact end, a driving end bore and an elongated body, against said anchor collar while said anchor nail is inserted within said driving tool driving end bore;
striking said driving tool impact end with a striking tool to forcibly insert said anchor body section into said pre-drilled hole until full seated;
removing said driving tool and forcibly inserting said nail into said anchor body section to secure said anchor into said pre-drilled hole.

5) The method of claim 4, further comprising the steps of:
inverting said driving tool and placing said impact end against said nail prior to insertion into said anchor body;
using said tool as a punch by striking said driving tool driving end with a striking tool to forcibly insert said nail into said anchor body.

6) The method of claim 4, further comprising the steps of:
positioning a work piece to be supported by said anchor between said pre-drilled hole and said anchor prior to driving said anchor into said pre-drilled hold, whereby said work piece is sandwiched between said anchor collar and said surface.
